(19) United States
(12) Patent Application Publication
(10) Pub. No.: US 2016/0083222 A1
(43) Pub. Date: Mar. 24, 2016

(54) GUIDE RAIL ALIGNMENT SYSTEMS FOR ELEVATORS

(71) Applicant: KONE Corporation, Helsinki (FI)

(72) Inventors: Alejandro Revuelta Fernandez, Espoo (FI); Mikael Haag, Vantaa (FI)

(73) Assignee: KONE Corporation, Helsinki (FI)

(21) Appl. No.: 14/956,009

(22) Filed: Dec. 1, 2015

Related U.S. Application Data
(63) Continuation of application No. PCT/FI2014/050537, filed on Jun. 27, 2014.

(30) Foreign Application Priority Data
Jul. 3, 2013 (EP) 13174819.6

(51) Int. Cl. B66B 7/02; B66B 5/00

(52) U.S. Cl. CPC B66B 7/026; B66B 5/0087

(57) ABSTRACT

A guide rail alignment system includes at least one connecting element, two guide rail sections, each section having two ends, joined to each other from one of their ends by the at least one connecting element, compression elements attaching at least one connecting element to the guide rail sections, and intermediate elements between the at least one connecting element and at least one of the guide rail sections. At least one of the intermediate elements is a spring that is compressible in response to tightening one or more of the compression elements.

### TECHNICAL FIELD

The present disclosure relates to a device and a method for correcting guide rail alignment errors.

### BACKGROUND ART

Guide rails are used to guide the vertical movement of an elevator in an elevator shaft. There are two guide rails on the opposite walls of the elevator shaft and the elevator is linked to the guide rails through guide shoes or guide rollers facing the guide rails. Guide rails are constructed from multiple guide rail sections that are connected to each other from their vertical ends to form a continuous guiding structure for the elevator. The connection between two adjacent guide rail sections is secured through a connecting element, for example a fishplate, that is attacked to both guide rail sections through bolts or similar. The guide rails are attached to the walls of the elevator shaft through brackets.

The accurate alignment of the adjacent guide rail sections is necessary to prevent disturbances in the elevator path when it moves over a junction of two guide rail sections and to ascertain that the guide shoes or guide rollers touch the guide rails appropriately throughout the entire length of the elevator movement. Currently, the correction of alignment errors, called shimming, is achieved through adding washers or shims between the guide rail section and the fishplate. When done appropriately, this both flattens out bends in the guide rail sections and moves the ends of the two guide rail sections to accurately face each other.

Guide rails are typically installed in the elevator shaft in a bottom-up manner. The vertical line in which each guide rail should run is first established with the aid of a plumb line or a laser beam. The two bottom-most guide rail sections, one on each opposite wall of the elevator shaft, are then attached to the walls through the brackets. The straightness of the guide rail sections is checked and adjusted through the brackets if necessary. Then, the next pair of guide rail sections is mounted on top of the first pair and attached to the wall as the previous guide rail sections. The straightness of the guide rail sections is checked in relation to the guide rail section below and adjusted through the brackets if necessary. The fishplate is then added at the formed junction and the ends are aligned. The process is repeated until both guide rails are complete. The final adjustment of the guide rail sections is carried out by shimming, i.e. by adding shims or washers between the guide rail section and the fishplate to force a slight curvature in the guide rail section in order to change the position of the end of a guide rail section. This corrects alignment errors in different directions that can result from tensions within the completed guide rail.

After the initial shimming at the construction phase of the elevator, it is usually necessary or recommended to repeat the process after the elevator has been taken into use, since both the building and the guide rail sections might slightly change their dimensions with time causing inaccurate alignment or bending of the guide rail sections.

In the patent document U.S. Pat. No. 4,079,817, a fish-plate comprising an intermediate portion to which the ends of the guide rail sections to be joined are affixed, and integral extensions which are spaced from the back surfaces of the adjacent guide rail sections is disclosed. The integral extensions include jacking bolts which are adjusted to provide forces on the guide rail sections correcting the misalignment of the guide rail sections and restraining the guide rail sections to hold the accurate position. Since the intermediate portion of the fishplate is thicker than the integral extensions, the jacking bolts can be adjusted to force the guide rail section to an appropriate position. However, according to U.S. Pat. No. 4,079,817, the bolts are screwed to the guide rail section from different directions depending on the direction of the misalignment of the guide rail sections (i.e. whether the bend is towards the inside of the elevator shaft or towards its wall). This means, that it might be necessary to remove the fishplate after it has been installed for changing the direction of the jacking bolts. Furthermore, in one orientation of the jacking bolts, there is no corresponding hole in the guide rail section (the jacking bolt needs to push the guide rail section relative to the fishplate), whereas in the other orientation a hole is needed for the adjustment (the jacking bolt needs to pull the guide rail section relative to the fishplate).

Drawbacks of the current solutions are that shimming has to be done manually, is time-consuming and requires significant expertise, thus making it expensive and inconvenient.

### SUMMARY OF THE INVENTION

An object of the present invention is to provide an improved guide rail alignment system and a method for correcting guide rail alignment errors.

The guide rail alignment system and the method for correcting guide rail alignment errors are in particular, but not only, intended for elevators, especially for passenger or cargo elevators of buildings. However, the guide rail alignment system and the method for correcting guide rail alignment errors may be used with other guide rails as well.

By a guide rail herein is meant a continuous rail that guides the substantially vertical movement of an elevator in an elevator shaft. By a guide rail section is meant a section of a guide rail that is attached from its one end to an adjacent guide rail section or from its both ends to two adjacent guide rail sections.

By correcting guide rail alignment errors (shimming) herein is meant a procedure in which the curvature of a guide rail section or the relative positions of two adjacent guide rail sections is adjusted with the aid of a connecting element, typically a fishplate, and components attached thereto in order to correct guide rail alignment errors.

By a guide rail alignment system is herein meant the connecting element, such as a fishplate, attached to two adjacent guide rail sections, intermediate elements, such as washers, shims, cup springs, leaf, springs or elastic spacers located between the guide rail section and the connecting element, the portions of both guide rail sections that are in contact with the connecting element, possibly through the said intermediate elements, and compression elements, such as bolts, screws, adjustable pins, clamps or tighteners, that attach the connecting element to the guide rail sections. The intermediate elements can be either separate or integrated into other elements of the guide rail alignment system.

By a spring is herein meant a body that is elastic and more compliant than the surrounding load-bearing structures.

The guide rail alignment system presented here is characterized by comprising at least one connecting element, two guide rail sections, each section having two ends, joined to each other from one of their ends by the at least one connecting element, compression elements attaching the at least one connecting element to the guide rail sections, and intermediate elements between the at least one connecting element and at least one of the guide rail sections, and further characterized in that at least one of the intermediate elements is a spring that is compressible in response to tightening one or more of the compression elements.

In another aspect there is disclosed a guide rail of an elevator, characterized in that it comprises at least one pair of guide rail sections connected through a guide rail alignment system according to the present disclosure.

In another aspect there is disclosed an elevator comprising an elevator shaft, at least one guide rail, an elevator car arranged to move within the elevator shaft along the at least one guide rail, characterized in that the elevator comprises at least one guide rail with at least one pair of guide rail sections connected through a guide rail alignment system according to the present disclosure.

In another aspect there is disclosed a method for correcting guide rail alignment errors comprising joining two guide rail sections, each section having two ends, to each other from one of their ends by at least one connecting element, attaching the at least one connecting element to the guide rail sections by compression elements, characterized in that the method comprises using spring force between the connecting element and at least one of the guide rail sections to correct guide rail section alignment errors, and adjusting the spring force by altering the tightness of at least one compression element.

The guide rail alignment system according to the present disclosure offers at least one of the following advantages over prior art:
The connecting element does not need to be released for correcting guide rail alignment errors. This speeds up the alignment correction process and avoids the loss of alignment in other dimensions of the guide rail than the one being corrected.
All the parts required for the correcting guide rail alignment errors can be incorporated into the guide rail alignment system already at installation so that the correction of alignment errors can be performed by screwing appropriate compression elements, such as bolts, screws, adjustable pins, clamps or tighteners, without the need to add or move parts between the connecting element and the guide rail section.
The maintenance of existing guide rail installations can be economized by replacing the existing guide rail alignment systems with guide rail alignment systems disclosed herein.

In one embodiment, the at least one connecting element and the two guide rail sections comprise holes that are arranged so, that the holes in the guide rail sections can be aligned with the holes in the connecting element and that the compression elements attach the at least one connecting element to the guide rail sections through the holes.

In one embodiment, the at least one spring is configured to exert pressure on the guide rail section to create a bending tension in it in the direction of the spring force in response to loosening one or more of the compression elements.

In another embodiment, the guide rail is configured to be attached to a solid support, wherein the bending tension in the guide rail section caused by the pressure from the partially released at least one spring is configured to alter curvature in the guide rail section and/or to adjust the relative positions of two adjacent guide rail sections.

In another embodiment, curvature of the guide rail section and/or the relative positions of two adjacent guide rail sections is configured to be altered by tightening one or more of the compression elements to a predetermined torque during installation and by thereafter loosening or further tightening one or more of the compression elements by a predetermined amount.

In another embodiment, the at least one spring is a cup spring, elastic spacer, leaf spring, helical spring, wave spring, or an integrated spring achieved through local elasticity of the connecting element or of the guide rail section.

In yet another embodiment, the at least one spring is sunken into the connecting element so, that when the compression elements are completely tightened, the connecting element is in contact with the guide rail sections with its whole guide-rail facing surface.

In yet another embodiment, the at least one spring is incorporated to the connecting element prior to the assembly of the guide rail alignment system.

In yet another embodiment, the guide rail alignment system contains one connecting element in which there are at least eight holes arranged in two rows of four in the direction of the guide rail.

In another embodiment, the method for correcting guide rail alignment errors according to the present disclosure is characterized in that the spring force is produced by at least one spring, and that the method comprises the steps of

a) during installation or service of the guide rail sections, creating a preload on the connecting element and guide rail junctions by tightening at least one of the compression elements to a predetermined torque; and

b) after the installation or service is completed, loosening or tightening at least one of the compression elements by a predetermined amount to correct alignment errors in the guide rail.

In yet another embodiment, the method for correcting guide rail alignment errors according to the present disclosure is characterized in that the spring force is produced by at least one spring, and that the method comprises the steps of

a) during installation or service of the guide rail sections, creating a preload on the connecting element and guide rail junctions by tightening at least one of the compression elements tightly; and

b) after the installation or service is completed, loosening at least one of the compression elements by a predetermined amount to correct alignment errors in the guide rail.

### DESCRIPTION OF DRAWINGS

The accompanying drawings, which are included to provide a further understanding of the invention and constitute a part of this specification, illustrate embodiments of the invention and together with the description help to explain the principles of the invention but the invention is not limited to the specific embodiments illustrated in the drawings. In the drawings:

FIG. 1 presents a schematic overview of one embodiment of the guide rail alignment system according to the present disclosure.

FIG. 2 presents a schematic overview of the embodiment in FIG. 1 viewed from the side.

FIG. 3A presents a schematic overview of the embodiment in FIG. 1 as a cross-sectional view along the plane A-A′ in preload position before correcting guide rail alignment errors.

FIG. 3B presents a schematic overview of the embodiment in FIG. 1 as a cross-sectional view along the plane B-B′ after correcting guide rail alignment errors.

FIG. 4A presents a pair of guide rail sections joined by a guide rail alignment system according to the present disclosure in preload position before correcting guide rail alignment errors.

FIG. 4B presents a pair of guide rail sections joined by a guide rail alignment system according to the present disclosure after correcting guide rail alignment errors.

FIG. 5 presents a schematic overview of an elevator in which a guide rail alignment system according to the present disclosure is used.

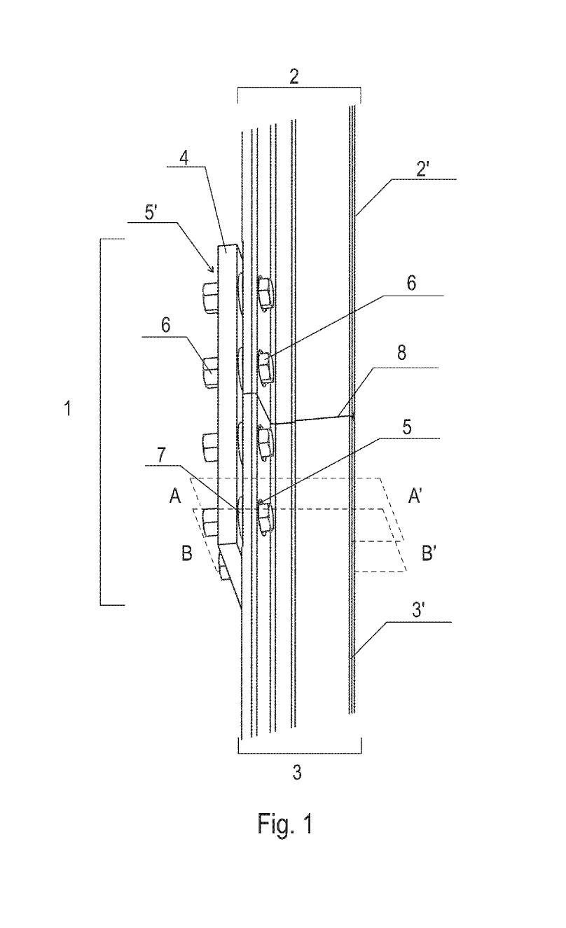

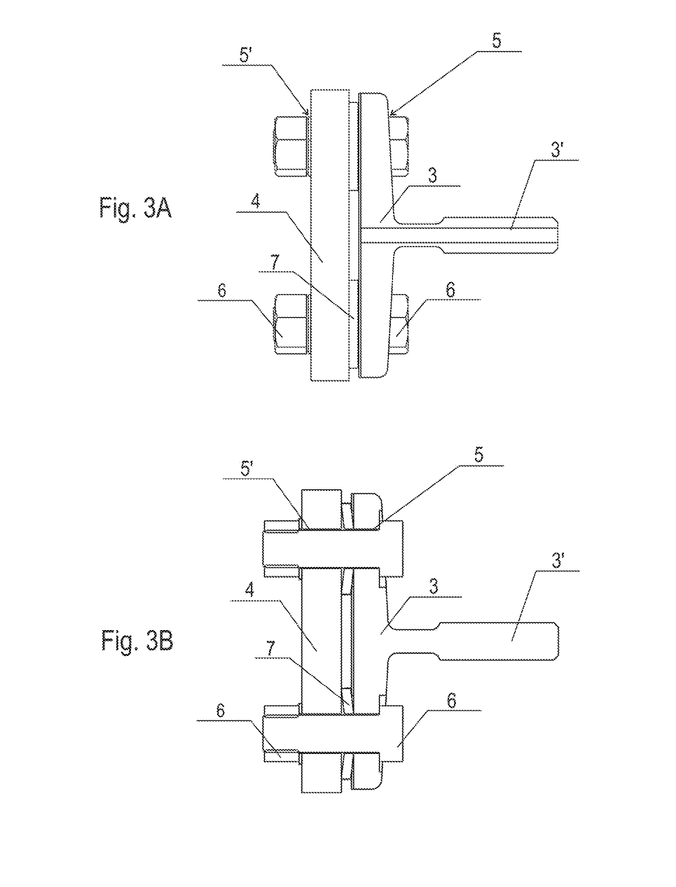

FIG. 1 presents a guide rail alignment system 1 with two guide rail sections 2, 3 joined by one connecting element 4, which in this case is a fishplate. The guide rail sections 2, 3 have a T-shaped cross-sectional profile (shown more closely in FIG. 3) and the guide rollers or guide shoes of the elevator car 11 move along the ridge (2′, 3′) of the guide rail sections 2, 3. The fishplate 4 is located on the side of the guide rail sections 2, 3 that faces the elevator shaft 10 wall. The guide rail sections 2, 3 are typically about 5 m long, although the length can vary. They also vary in their width in different elevator constructions, but can have a width of, for example, 127 mm. The fishplate 4 is approximately as wide as the guide rail sections 2, 3, and in the above-mentioned case 130 mm. Also the length of the fishplate 4 varies and can be, for example, 305 mm for the above guide rail sections 2, 3. The thinnest fish-plates 4 can be only 5 mm thick, but a thickness of, for example, 17 mm can be considered typical. The fishplates 4 can also have additional rigidifying structures, such as ridges in them, which are omitted from the figure.

In this embodiment, the fishplate 4 is attached to each guide rail section 2, 3 through four compression elements 6, which in this case are bolts and their respective holes 5′, 5 in the fishplate 4 and in the guide rail sections 2, 3. The holes are arranged in two rows of four holes 5, 5′ in the direction of the guide rail 12, but this does not need to be the only arrangement. A smaller or larger number of holes 5, 5′ and their respective bolts 6 is possible, depending on the heaviness of the structure and the forces necessary to correct the alignment errors in the guide rail sections 2, 3. The number of the bolts 6 and their respective holes 5, 5′ do not need to be the same for both guide rail sections 2, 3 in a given guide rail alignment system 1. The bolts 6 can alternatively be screws, adjustable pins, clamps or tighteners, or other compression elements depending on the specific embodiment in question and also the spacing of the holes 5, 5′ with compression elements 6 can vary.

The guide rail section 2, 3 and the connecting element 4 do not need to be attached to each other through compression elements 6 that need holes 5, 5′. The compression elements 6 can be adjustable clamps, presses or other tighteners. When there are holes 5, 5′ in the guide rail sections 2, 3 and connecting elements 4, the holes 5, 5′ do not need to be circular. Further, they can have an opening to the side of the guide rail section 2, 3 or connecting element 4 or both, forming a slot rather than a hole with a closed circumference.

It is possible to have more than one connecting element 4 per guide rail alignment system 1: for example a configuration of two narrow connecting elements 4 with a single row of holes 5′ and compression elements 6 in each can be envisaged.

There are intermediate elements 7 between the guide rail sections 2, 3 and the fishplate 4 that in the embodiment of FIG. 1 are cup springs 7 through which the bolts 6 are fitted. In FIG. 1, the guide rail alignment system 1 is depicted in the preload position, i.e. with the cup springs 7 fully compressed by the bolts 6. The fishplate 4 does not touch the guide rail sections 2, 3 directly, but only through the springs 7. In another embodiment, the cup springs or other intermediate elements 7 could be sunken into the connecting element 4 so, that in the preload position the connecting element 4 and the guide rail sections 2, 3 would contact each other directly. Further, although in this embodiment, there are springs 7 in all positions of the bolts 6 and holes 5, 5′, this is not necessary, if sufficient adjustment can be achieved with a smaller number of springs 7. For example, there could be springs 7 in conjunction only with the bolts 6 on one side of the guide rail junction 8 or only in certain positions on both sides of the guide rail junction 8. Although in this example the intermediate elements 7 are fully compressed, it is possible to compress them only to a predetermined torque, for example 120 Nm by using, for example, a torque wrench. This allows the correction of guide rail 12 alignment errors by either increasing the bending moment or by decreasing it through tightening the compression element 6 further or loosening it, respectively.

The springs 7 have to be compressible enough to allow them to be released, for example, 0.5 mm from the preload position, and to still retain enough mechanical energy to exert a sufficiently large force on the guide rail section 2, 3. The magnitude of the force and movement parameters vary broadly in different constructions and have to be adjusted for different guide rail section 2, 3 configurations.

The material for the construction of all parts is usually steel, but also other materials might be suitable.

The guide rail alignment system 1 of the present disclosure can be used in a guide rail 12 together with guide rail alignment systems 1 known in prior art. When servicing old elevator installations, it might be economical to replace only some of the guide rail alignment systems 1 with ones according to the present disclosure in order to save working time, but allow for the convenient correction of guide rail 12 alignment errors brought about by the guide rail alignment system 1 presented here.

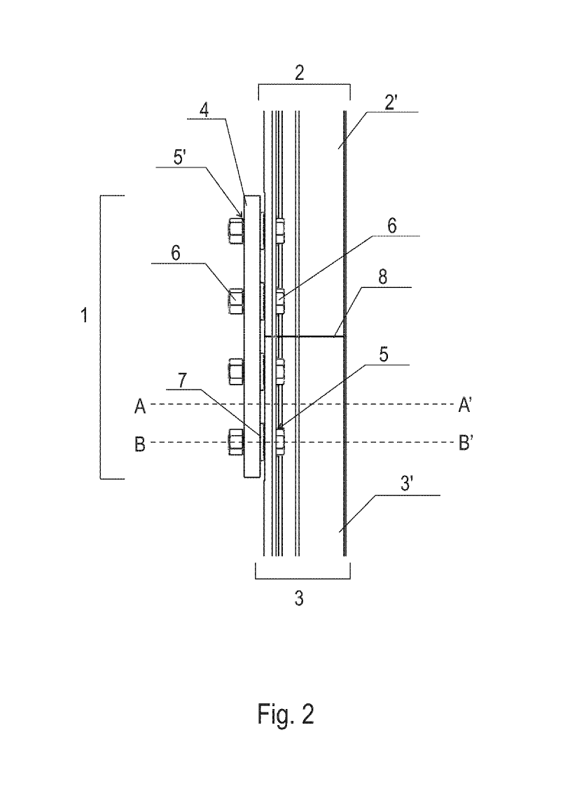

FIG. 2 presents the guide rail alignment system 1 of FIG. 1 viewed from one side. The guide rail sections 2, 3 are accurately aligned and the cup springs 7 fully compressed between the fishplate 4 and the guide rail sections 2, 3 by the bolts 6. This is the ideal initial preload position after the installation of the guide rail sections 2, 3. If the springs 6 were sunken into holes, the fishplate 4 and the guide rail 12 could be pressed against each other throughout the length of the fishplate 4.

It is not always feasible to install the guide rail sections 2, 3 as accurately as depicted in FIG. 2. The tensions within the guide rail sections 2, 3 might force the initial position of the guide rail section 2, 3 ends to deviate from a straight line in different directions. After the installation of more than two guide rail sections 2, 3, the alignment errors can be corrected within the guide rail alignment system 1 in question, or in one or more of the other guide rail alignment systems 1 in the particular guide rail 12.

FIG. 3A presents the guide rail alignment system 1 of FIG. 1 as a cross-sectional view along the plane A-A′ in preload position before correcting guide rail 12 alignment errors.

In this view, it can be seen that the guide rail section 3 has a T-shaped cross-sectional profile with a ridge 3′. The surface of the guide rail section 3 that the bolts 6 attach to is slightly sloped relative to the surface facing the fishplate 4. Therefore, there are indentations in the guide rail section 3 around each hole 5 to provide a horizontal surface for the bolts 6 in the direction of their tightening. In the preload position, the cup springs 7 are fully compressed. However, it would be possible to tighten the springs 7 to a predetermined torque instead of compressing them fully before correcting the guide rail 12 alignment errors. Thereafter, the guide rail 12 alignment errors could be corrected either by loosening the springs 7 or tightening them further by a predetermined amount.

FIG. 3B presents the guide rail alignment system 1 of FIG. 1 as a cross-sectional view along the plane B-B′ after correcting guide rail 12 alignment errors. The bolts 6 have been loosened and, compared to FIG. 3A, the guide rail section 3 and the fishplate 4 are further apart. The cup springs 7 are less compressed and exert a bending tension on the guide rail section 3.

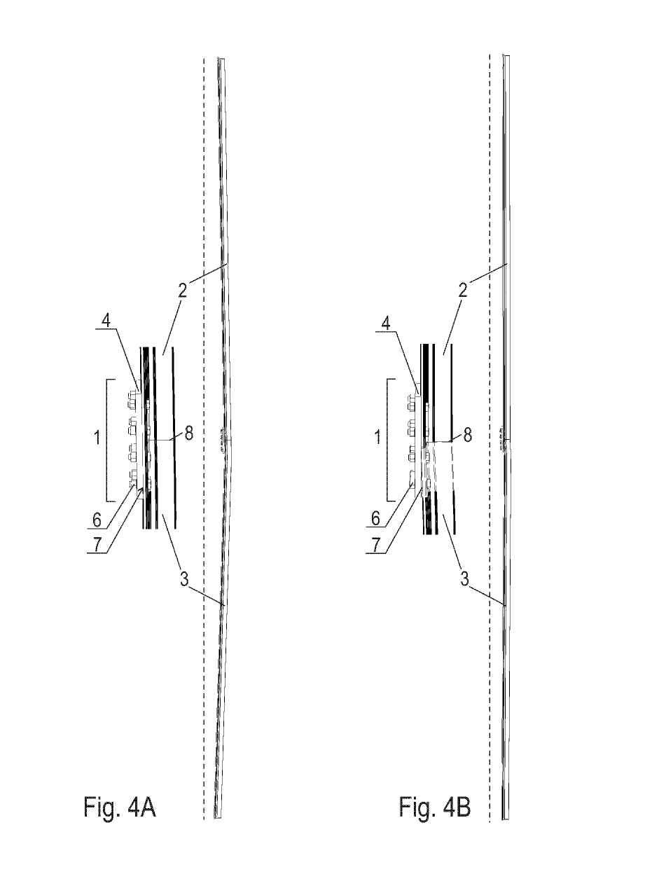

FIG. 4A presents a pair of guide rail sections 2, 3 joined by a guide rail alignment system 1 in preload position before correcting guide rail 12 alignment errors. The guide rail sections 2, 3 are mounted on the elevator shaft 10 wall by brackets 14 (not shown). A detail view of the guide rail alignment system 1 is also shown.

In the embodiment of FIG. 4A, the intermediate elements 7, which in this embodiment are cup springs, are sunken in the connecting element 4, which in this embodiment is a fishplate, allowing the fishplate 4 and the guide rail sections 2, 3 to contact each other directly throughout the length of the fishplate 4. All the compression elements, which in this embodiment are bolts 6, are tightened completely, i.e. the complete length of their compression range is used. In cases where the alignment errors would be of different magnitude, direction or position, it is possible that not all the bolts 6 are fully tightened even in the preload position. The guide rail sections 2, 3 are twisted so, that they do not form a straight guide rail 12 structure (indicated by the dashed line).

FIG. 4B presents the pair of guide rail sections 2, 3 joined by a guide rail alignment system 1 of FIG. 4A after correcting guide rail 12 alignment errors. A detail view of the guide rail alignment system 1 is also shown. The bolts 6 attached to the guide rail section 3 of the guide rail alignment system 1 have been loosened. The partially released bolts 6 allow the cup springs 7 to press against the guide rail section 3 creating a bending tension and force between the guide rail sections 2 and 3. Both the guide rail sections 2 and 3 have straightened relative to the straight line as was aimed for by the procedure (indicated by the dashed line).

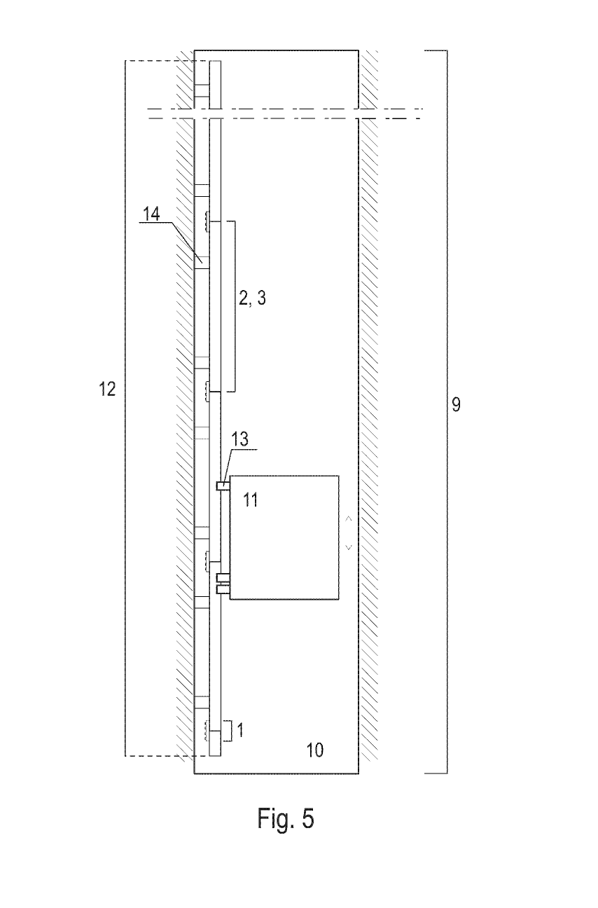

FIG. 5 presents an elevator 9 comprising an elevator shaft 10, an elevator car 11 arranged to move within the elevator shaft 10 (indicated by the double-headed arrow), a guide rail 12 and guide shoes or rollers 13 that move along the guide rail 12. The guide rail 12 comprises guide rail sections 2, 3 and guide rail alignment systems 1, and is attached to the elevator shaft 10 wall through brackets 14.

All support, controlling and safety devices for the elevator 9 are omitted from the picture for clarity, and any conventional methods can be used for their design. All parts of the elevator 9 are depicted only schematically and their sizes are not drawn proportionally. Although only one guide rail 12 is shown in FIG. 5, there typically are two of them in each elevator 9.

Guide rail alignment systems 1 according to the present disclosure can be used in all guide rail junctions 8 of the elevator 9 or one or more guide rail alignment systems 1 can be according to prior art and used in combination with the guide rail alignment systems 1 disclosed herein.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A guide rail alignment system comprising:
at least one connecting element;
two guide rail sections, each guide rail section having two ends, joined to each other from one of their ends by the at least one connecting element;
compression elements attaching the at least one connecting element to the guide rail sections; and
intermediate elements between the at least one connecting element and at least one of the guide rail sections,
wherein at least one of the intermediate elements is a spring that is compressible in response to tightening one or more of the compression elements.

2. The guide rail alignment system according to claim 1, wherein the at least one connecting element and the two guide rail sections comprise holes that are arranged so, that the holes in the guide rail sections can be aligned with the holes in the connecting element and that the compression elements attach the at least one connecting element to the guide rail sections through the holes.

3. The guide rail alignment system according to claim 1, wherein the at least one spring is configured to exert pressure on the guide rail section to create a bending tension in it in the direction of the spring force in response to loosening one or more of the compression elements.

4. The guide rail alignment system according to claim 3, wherein the guide rail is configured to be attached to a solid support, wherein the bending tension in the guide rail section caused by the pressure from the partially released at least one spring is configured to alter curvature in the guide rail section and/or to adjust the relative positions of two adjacent guide rail sections.

5. The guide rail alignment system according to claim 1, wherein the curvature of the guide rail section and/or the relative positions of two adjacent guide rail sections is configured to be altered by tightening one or more of the compression elements to a predetermined torque during installation and by thereafter loosening or further tightening one or more of the compression elements by a predetermined amount.

6. The guide rail alignment system according to claim 1, wherein the at least one spring is a cup spring, elastic spacer, leaf spring, helical spring, wave spring, or an integrated spring achieved through local elasticity of the connecting element or of the guide rail section.

7. The guide rail alignment system according to claim 1, wherein the at least one spring is sunken into the connecting element so, that when the compression elements are completely tightened, the connecting element is in contact with the guide rail sections with its whole guide-rail facing surface.

8. The guide rail alignment system according to claim 1, wherein the at least one spring is incorporated to the connecting element prior to the assembly of the guide rail alignment system.

9. The guide rail alignment system according to claim 1, wherein the guide rail alignment system contains one connecting element in which there are at least eight holes arranged in two rows of four in the direction of the guide rail.

10. A guide rail of an elevator, characterized in that it comprises comprising at least one pair of guide rail sections connected through the guide rail alignment system according to claim 1.

11. An elevator comprising:
an elevator shaft;
at least one guide rail; and
an elevator car arranged to move within the elevator shaft along the at least one guide rail,
wherein the elevator comprises at least one guide rail with at least one pair of guide rail sections connected through the guide rail alignment system according to claim 1.

12. A method for correcting guide rail alignment errors comprising the steps of:
joining two guide rail sections, each guide rail section having two ends, to each other from one of their ends by at least one connecting element;
attaching at least one connecting element to the guide rail sections by compression elements;
using spring force between the connecting element and at least one of the guide rail sections to correct guide rail section alignment errors; and
adjusting the spring force by altering the tightness of at least one compression element.

13. The method for correcting guide rail alignment errors according to claim 12, wherein the spring force is produced by at least one spring, and the method further comprises the steps of:
a) during installation or service of the guide rail sections, creating a preload on the connecting element and guide rail junctions by tightening at least one of the compression elements to a predetermined torque; and
b) after the installation or service is completed, loosening or tightening at least one of the compression elements by a predetermined amount to correct alignment errors in the guide rail.

14. The method for correcting guide rail alignment errors according to claim 12, wherein the spring force is produced by at least one spring, and the method further comprises the steps of:
a) during installation or service of the guide rail sections, creating a preload on the connecting element and guide rail junctions by tightening at least one of the compression elements tightly; and
b) after the installation or service is completed, loosening at least one of the compression elements by a predetermined amount to correct alignment errors in the guide rail.

15. The guide rail alignment system according to claim 2 wherein the at least one spring is configured to exert pressure on the guide rail section to create a bending tension in it in the direction of the spring force in response to loosening one or more of the compression elements.

16. The guide rail alignment system according to claim 2, wherein the curvature of the guide rail section and/or the relative positions of two adjacent guide rail sections is configured to be altered by tightening one or more of the compression elements to a predetermined torque during installation and by thereafter loosening or further tightening one or more of the compression elements by a predetermined amount.

17. The guide rail alignment system according to claim 3, wherein the curvature of the guide rail section and/or the relative positions of two adjacent guide rail sections is configured to be altered by tightening one or more of the compression elements to a predetermined torque during installation and by thereafter loosening or further tightening one or more of the compression elements by a predetermined amount.

18. The guide rail alignment system according to claim 4, wherein the curvature of the guide rail section and/or the relative positions of two adjacent guide rail sections is configured to be altered by tightening one or more of the compression elements to a predetermined torque during installation and by thereafter loosening or further tightening one or more of the compression elements by a predetermined amount.

19. The guide rail alignment system according to claim 2, wherein the at least one spring is a cup spring, elastic spacer, leaf spring, helical spring, wave spring, or an integrated spring achieved through local elasticity of the connecting element or of the guide rail section.

20. The guide rail alignment system according to claim 3, wherein the at least one spring is a cup spring, elastic spacer, leaf spring, helical spring, wave spring, or an integrated spring achieved through local elasticity of the connecting element or of the guide rail section.
